(19) United States
(12) Patent Application Publication
(10) Pub. No.: US 2013/0225165 A1
(43) Pub. Date: Aug. 29, 2013

(54) OUT-OF-BAND SCANNING FOR FEMTO ACCESS POINT DETECTION

(71) Applicants: Soumya DAS, San Diego, CA (US); Damanjit SINGH, San Diego, CA (US); Samir Salib SOLIMAN, San Diego, CA (US)

(72) Inventors: Soumya DAS, San Diego, CA (US); Damanjit SINGH, San Diego, CA (US); Samir Salib SOLIMAN, San Diego, CA (US)

(73) Assignee: QUALCOMM INCORPORATED, San Diego, CA (US)

(21) Appl. No.: 13/408,210

(22) Filed: Feb. 29, 2012

(51) Int. Cl. H04W 48/16

(52) U.S. Cl. 455/434

(57) ABSTRACT

Scanning for femto access points includes scanning out-of-band (OOB) channels to discover OOB signals associated with the femto access point. When a femto access point is first discovered, a first type of scan is performed of each of the OOB channels. The user equipment (UE) determines whether any received responses originate from femto OOB access points and, if so, updates a search database of the UE. During subsequent visits to the area of the femto OOB access points, when the UE detects entry to a fingerprint area of the femto OOB access point, a second type of scan is performed, in which each of the OOB channels with femto OOB access points identified in the search database are scanned. If responses are detected to this second type of scan, a proximity indication is transmitted using in-band signals to a serving macro access point.

### CROSS-REFERENCE TO RELATED APPLICATIONS

This application is related to U.S. patent application Ser. No. 13/399,404, Attorney Docket No. 111686U1, entitled, “PROXIMITY INDICATION USING OUT-OF-BAND LINK”, filed on Feb. 17, 2012, which is expressly incorporated by reference herein in its entirety.

### BACKGROUND

1. Field

Aspects of the present disclosure relate generally to wireless communication systems, and more particularly, to out-of-band (OOB) scanning for femto access point detection.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or NodeBs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

Representative aspects of the present disclosure are directed to scanning for femto out-of-band (OOB) access points over OOB channels. Two types of scans are disclosed. A first type of scan is performed when a CSG/femto access point is discovered for the first time or when the femto access point search information database (SID) is to be updated. In the first scan type active or passive scanning are used to scan each OOB channel for femto OOB access points. When responses are received to the first scan type, either probe responses or detected beacons, the UE will determine whether the responses originate from femto OOB access points and, if so, will populate or update the SID with OOB identification information. During the first scan type, no proximity information is determined to assist in proximity indication reporting.

In additional representative aspects, the second type of scanning is used during subsequent visits to areas covered by femto OOB access points for which OOB identification information exists in the SID after the first type of scan. The second type of scan may be initiated by a triggering event, such as when the mobile device detects entry into the fingerprint area associated with the femto OOB access points. Once triggered, the UE scans the channels on which femto OOB access points on a list from the SID that have been identified. When the UE receives responses to the second type of scan, it will report a proximity indication for the femto OOB access point to a serving radio network controller (RNC) through a base station using in-band signals over WWAN.

In one aspect of the disclosure, a method of scanning for a CSG/hybrid femto access point that includes performing a first scan type, by a mobile device, over a plurality of OOB channels for OOB signals associated with the CSG/hybrid femto access point, wherein the first scan type is performed in response to detecting the CSG/hybrid femto access point for a first time over an in-band channel. The method further includes determining, at the mobile device, whether one or more OOB responses originate from a femto OOB access point, wherein the one or more OOB responses are detected in response to the first scan type, and generating, by the mobile device, mapping information mapping one or more OOB identifiers associated with the femto OOB access point with one or more in-band identifiers associated with the femto OOB access point in response to determining the one or more OOB responses originate from the femto OOB access point. The method further includes updating a search database stored on the mobile device with the mapping information.

In an additional aspect of the disclosure, a method of scanning for a CSG/hybrid femto access point includes performing a second scan type, by a mobile device, over one or more OOB channels associated with one or more femto OOB access points identified in a search database stored on the mobile device, receiving, at the mobile device, one or more responses in response to the second scan type, and reporting a proximity indication, by the mobile device, over an in-band link, wherein the proximity indication indicates proximity of the mobile device to one or more responding femto OOB access points from which the one or more responses are received.

In an additional aspect of the disclosure, a method of reporting proximity to a CSG/hybrid femto access point includes detecting, by a mobile device, a location of the mobile device within at least one neighbor macro coverage areas around the CSG/hybrid femto access point. The method further includes starting a timer in response to the detecting and transmitting, over in-band signaling, a proximity indication to a serving base station when the timer reaches a predetermined time offset, wherein the proximity indication indicates the mobile device being proximate to the CSG/hybrid femto access point.

In an additional aspect of the disclosure, an apparatus of scanning for a CSG/hybrid femto access point that includes means for performing a first scan type, by a mobile device, over a plurality of OOB channels for OOB signals associated with the CSG/hybrid femto access point, wherein the first scan type is performed in response to detecting the CSG/hybrid femto access point for a first time over an in-band channel. The apparatus also includes means for determining, at the mobile device, whether one or more OOB responses originate from a femto OOB access point, wherein the one or more OOB responses are detected in response to the first scan type, means for generating, by the mobile device, mapping information mapping one or more OOB identifiers associated with the femto OOB access point with one or more in-band identifiers associated with the femto OOB access point in response to determining the one or more OOB responses originate from the femto OOB access point, and means for updating a search database stored on the mobile device with the mapping information.

In an additional aspect of the disclosure, an apparatus of scanning for a CSG/hybrid femto access point that includes means for performing a second scan type, by a mobile device, over one or more OOB channels associated with one or more femto OOB access points identified in a search database stored on the mobile device, means for receiving, at the mobile device, one or more responses in response to the second scan type, and means for reporting a proximity indication, by the mobile device, over an in-band link, wherein the proximity indication indicates proximity of the mobile device to one or more responding femto OOB access points from which the one or more responses are received.

In an additional aspect of the disclosure, an apparatus of reporting proximity to a CSG/hybrid femto access point includes means for detecting, by a mobile device, a location of the mobile device within at least one neighbor macro coverage areas around the CSG/hybrid femto access point. The apparatus further includes means for starting a timer in response to results of the means for detecting and means for transmitting, over in-band signaling, a proximity indication to a serving base station when the timer reaches a predetermined time offset, wherein the proximity indication indicates the mobile device being proximate to the CSG/hybrid femto access point.

In an additional aspect of the disclosure, a computer program product has a computer-readable medium having program code recorded thereon. This program code includes code to perform a first scan type, by a mobile device, over a plurality of OOB channels for OOB signals associated with the CSG/hybrid femto access point, wherein the first scan type is performed in response to detecting the CSG/hybrid femto access point for a first time over an in-band channel. The program code also includes code to determine, at the mobile device, whether one or more OOB responses originate from a femto OOB access point, wherein the one or more OOB responses are detected in response to the first scan type, code to generate, by the mobile device, mapping information mapping one or more OOB identifiers associated with the femto OOB access point with one or more in-band identifiers associated with the femto OOB access point in response to determining the one or more OOB responses originate from the femto OOB access point, and code to update a search database stored on the mobile device with the mapping information.

In an additional aspect of the disclosure, a computer program product has a computer-readable medium having program code recorded thereon. This program code includes code to perform a second scan type, by a mobile device, over one or more OOB channels associated with one or more femto OOB access points identified in a search database stored on the mobile device, code to receive, at the mobile device, one or more responses in response to the second scan type, and code to report a proximity indication, by the mobile device, over an in-band link, wherein the proximity indication indicates proximity of the mobile device to one or more responding femto OOB access points from which the one or more responses are received.

In an additional aspect of the disclosure, a computer program product has a computer-readable medium having program code recorded thereon. This program code includes code to detect, by a mobile device, a location of the mobile device within at least one neighbor macro coverage areas around the CSG/hybrid femto access point. The program code also includes code to start a timer executable in response to results of executing the program code to detect and code to transmit, over in-band signaling, a proximity indication to a serving base station when the timer reaches a predetermined time offset, wherein the proximity indication indicates the mobile device being proximate to the CSG/hybrid femto access point.

In an additional aspect of the disclosure, an apparatus includes at least one processor and a memory coupled to the processor. The processor is configured to performing a first scan type, by a mobile device, over a plurality of OOB channels for OOB signals associated with the CSG/hybrid femto access point, wherein the first scan type is performed in response to detecting the CSG/hybrid femto access point for a first time over an in-band channel. The processor is further configured to determine, at the mobile device, whether one or more OOB responses originate from a femto OOB access point, wherein the one or more OOB responses are detected in response to the first scan type, to generate, by the mobile device, mapping information mapping one or more OOB identifiers associated with the femto OOB access point with one or more in-band identifiers associated with the femto OOB access point in response to determining the one or more OOB responses originate from the femto OOB access point; and to update a search database stored on the mobile device with the mapping information.

In an additional aspect of the disclosure, an apparatus includes at least one processor and a memory coupled to the processor. The processor is configured to perform a second scan type, by a mobile device, over one or more OOB channels associated with one or more femto OOB access points identified in a search database stored on the mobile device, to receive, at the mobile device, one or more responses in response to the second scan type, and to report a proximity indication, by the mobile device, over an in-band link, wherein the proximity indication indicates proximity of the mobile device to one or more responding femto OOB access points from which the one or more responses are received.

In an additional aspect of the disclosure, an apparatus includes at least one processor and a memory coupled to the processor. The processor is configured to detect, by a mobile device, a location of the mobile device within at least on neighbor macro coverage areas around the CSG/hybrid femto access point. The processor is further configured to start a timer in response to the detection and to transmit, over in-band signaling, a proximity indication to a serving base station when the timer reaches a predetermined time offset, wherein the proximity indication indicates the mobile device being proximate to the CSG/hybrid femto access point.

### BRIEF DESCRIPTION OF THE DRAWINGS

FIG. 1 is a block diagram conceptually illustrating an example of a mobile communication system.

FIG. 2 is a block diagram illustrating a design of a base station/access point and a UE, which may be one of the base stations/access points and one of the UEs in FIG. 1.

FIG. 3 is a block diagram illustrating a detail of a UE configured according to one aspect of the present disclosure.

FIG. 4 is a functional block diagram illustrating example blocks executed to implement one aspect of the present disclosure.

FIG. 5 is a block diagram illustrating a UE configured according to one aspect of the present disclosure.

FIG. 6 is a functional block diagram illustrating example blocks executed to implement one aspect of the second scan type of the present disclosure.

FIG. 7 is a functional block diagram illustrating detailed blocks executed to implement the second scan type configured according to one aspect of the present disclosure.

FIG. 8 is a block diagram illustrating a detail of a UE configured according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wide area or local area wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95, IS-856, and 1xEV-DO standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000®, 1xEV-DO, and UMB are described in documents from an organization called the “3rd Generation Partnership Project 2” (3GPP2). The techniques described herein may be used for the wireless networks and radio access technologies mentioned above, as well as other wireless networks and radio access technologies. While the various aspects and alternatives of the present disclosure may be applicable to numerous types of network technologies, such as LTE, UMTS, and the like, the aspects described herein are disclosed with respect to UMTS network technology. However, it will be understood that the various aspects of the present disclosure are not limited to application in UMTS systems.

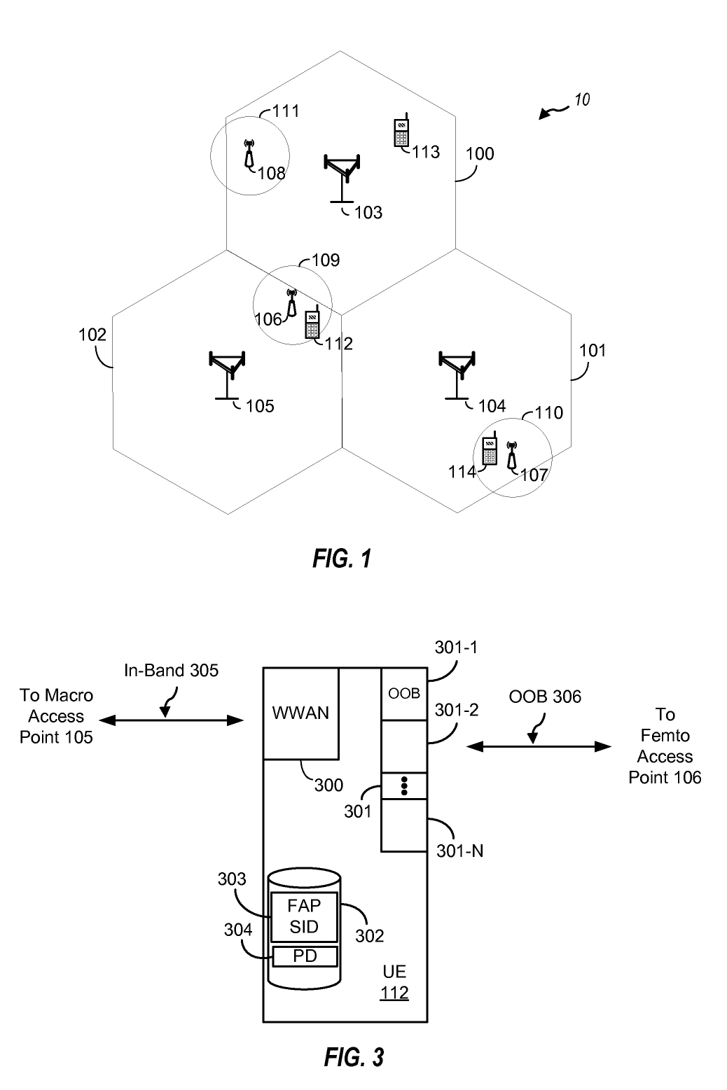

FIG. 1 shows a wireless network 10 for communication. Wireless network 10 may be an UMTS network. The wireless network 10 includes a number of access points (APs) 103-108 and other network entities. An access point may be a station that communicates with the UEs and may also be referred to as a base station, a NodeB (NB), an access point, and the like. Each of access points 103-108 may provide communication coverage for a particular geographic coverage area. Access points 103-108 each provide communication coverage in coverage areas 100-102 and 109-111, respectively.

An access point may provide communication coverage for a macro coverage area, a pico coverage area, a femto coverage area, and/or other types of coverage areas. A macro coverage area, such as coverage areas 100-102, generally covers a relatively large geographic area (e.g., several kilometers in radius) and may allow unrestricted access by UEs with service subscriptions with the network provider. A pico coverage area, such as coverage area 111, may generally cover a relatively smaller geographic area and may allow unrestricted access by UEs with service subscriptions with the network provider. A femto coverage area, such as coverage areas 109-110, may also generally cover an even smaller area (e.g., a home, a room, or the like) and, in addition to unrestricted access, may also provide restricted access by UEs having an association with the femto coverage area (e.g., UEs in a closed subscriber group (CSG), UEs for users in the home, and the like). An access point for a macro coverage area may be referred to as a macro access point. An access point for a pico coverage area may be referred to as a pico access point or generally as a femto access point along with an access point for a femto coverage area. For purposes of this application, “femto access point” will be used to refer to access points that are not macro access points, such as femto access points, pico access points, home NodeBs (HNBs), and the like. In the example shown in FIG. 1, the access points 103-105 are macro access points for the macro coverage areas 100-102, respectively. The access points 106-108 are a femto access points for the femto coverage areas 109-110 and the pico coverage area 111. An access point may support one or multiple (e.g., two, three, four, and the like) coverage areas.

The wireless network 10 may support synchronous or asynchronous operation. For synchronous operation, the access points may have aligned frame timing, and transmissions from different access points may be aligned in time. For asynchronous operation, the access points may have different frame timing, and transmissions from different access points may not be aligned in time. The techniques described herein may be used for either synchronous or asynchronous operations.

The UEs 112-114 are dispersed throughout the wireless network 10, and each UE may be stationary or mobile. A UE may also be referred to as a terminal, a mobile station, a mobile equipment, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro access points, femto access points, relays, and the like.

The wireless network 10 uses the diverse set of access points 103-108 (e.g., macro access points and femto access points) to improve the spectral efficiency of the system per unit area. Because the wireless network 10 uses such different access points for its spectral coverage, it may also be referred to as a heterogeneous network. The macro access points 103-105 are usually carefully planned and placed by the provider of the wireless network 10. The macro access points 103-105 generally transmit at high power levels (e.g., 5 W-40 W). The femto access point 108 defining the pico coverage area 111 generally transmits at substantially lower power levels (e.g., 100 mW-2 W), and may be deployed in a relatively unplanned manner to eliminate coverage holes in the coverage area provided by the macro access points 103-105 and improve capacity in the hot spots. The femto access points 109-110, which are typically deployed independently from the wireless network 10 may, nonetheless, be incorporated into the coverage area of the wireless network 10 either as a potential access point to the wireless network 10, if authorized by their administrator(s), or at least as an active and aware access point that may communicate with the other access points 103-105 and 108 of the wireless network 10. The femto access points 106-107 typically also transmit at substantially lower power levels (e.g., 100 mW-200 mW) than the macro access points 103-105.

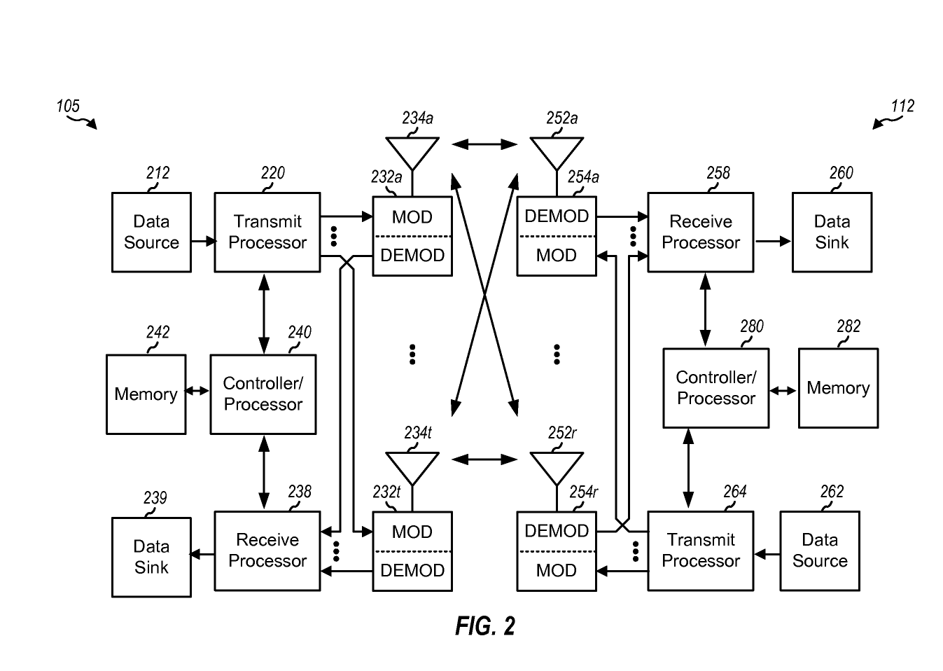

FIG. 2 shows a block diagram of a design of a base station/access point 105 and a UE 112, which may be one of the base stations/access points and one of the UEs in FIG. 1. For a restricted association scenario, the access point 105 may be the macro access point 105 in FIG. 1, and the UE 112 may be the UE 112. The access point 105 may also be a base station of some other type that performs, among other things various physical layer functions (modulation, coding, interleaving, rate adaptation, spreading, and the like). The access point 105 maintains communication with a radio network controller (RNC) (not shown) that controls the radio resources in the related coverage areas through its associated base stations, such as access point 105. The access point 105 may be equipped with antennas 234a through 234t, and the UE 112 may be equipped with antennas 252a through 252r.

At the access point 105, a transmit processor 220 may receive data from a data source 212 and control information from a controller/processor 240. The transmit processor 220 may process and code the data and control information and may provide output streams to the modulators (MODs) 232a through 232t. Each modulator 232 may process a respective output stream to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 112, the antennas 252a through 252r may receive the downlink signals from the access point 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples to obtain received symbols. A receive processor 258 may process (e.g., demodulate, deinterleave, and decode) the detected symbols, provide decoded data for the UE 112 to a data sink 260, and provide decoded control information to a controller/processor 280.

On the uplink, at the UE 112, a transmit processor 264 may receive and process data from a data source 262 and control information from the controller/processor 280. The processed data and control information from the transmit processor 264 may be processed by the demodulators 254a through 254r, and transmitted to the access point 105. At the access point 105, the uplink signals from the UE 112 may be received by the antennas 234, processed by the modulators 232, and further processed by a receive processor 238 to obtain decoded data and control information sent by the UE 112. The processor 238 may provide the decoded data to a data sink 239 and the decoded control information to the controller/processor 240.

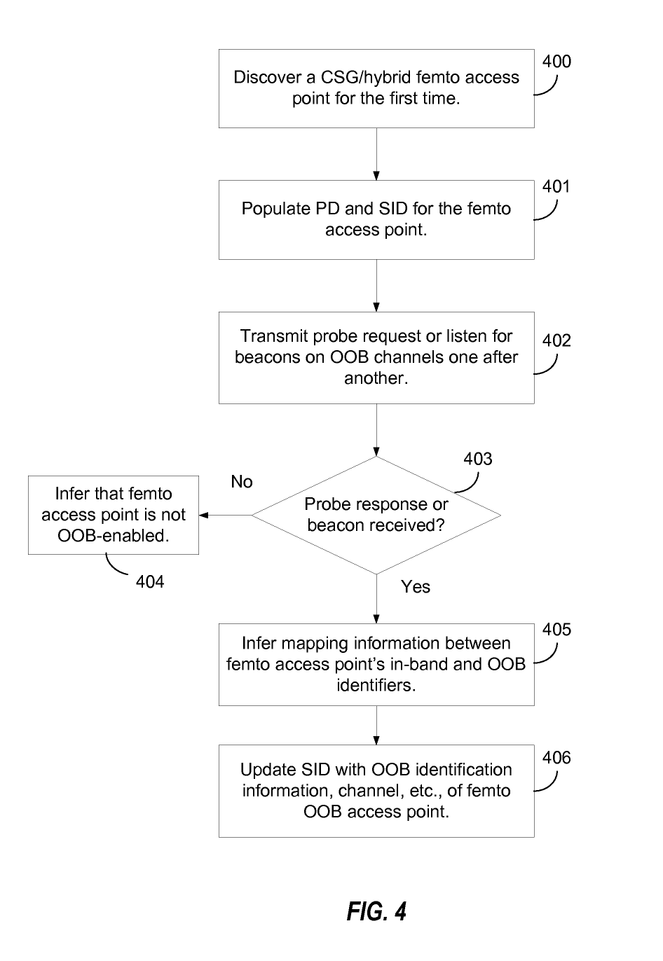

The controllers/processors 240 and 280 may direct the operation at the access point 105 and the UE 112, respectively. The controller/processor 240 and/or other processors and modules at the access point 105 may perform or direct the execution of various processes for the techniques described herein. The controllers/processor 280 and/or other processors and modules at the UE 112 may also perform or direct the execution of the functional blocks illustrated in FIGS. 4, 6, and 7, and/or other processes for the techniques described herein. The memories 242 and 282 may store data and program codes for the access point 105 and the UE 112, respectively.

Femto access points, such as femto access points 106-107 deployed in a UMTS High Speed Packet Access (HSPA) system or Release 99 of UMTS, may also be referred to as home NBs (HNBs). Femto access points deployed in LTE systems may be referred to as home evolved NodeBs (HeNBs) when deployed in a home access context. For purposes of this disclosure HeNBs and HNBs will be collectively referred to as HNBs or referred to generally as femto access points. Deployment of HNBs or femto access points offers to enhance coverage and data rates for home environments while freeing bandwidth for the macro access points serving the area in which the HNB or femto access point is deployed. The femto access point functionality and interfaces may be basically the same as for regular macro access points. When femto access points are deployed in the wireless network, the network is able to control the femto access point's interactions with the network, such as to activate or deactivate the femto access point, verify the ID and geographic location, determine state, and the like.

It should further be noted that the various aspects of the present disclosure are equally applicable in UMTS, LTE, and the like wireless technologies. Accordingly, for purposes of this disclosure, macro evolved NodeBs (LTE) and macro NodeBs (UMTS) will be collectively referred to as macro access points. One of skill in the art would easily understand the structural and technical differences between various wireless communication technologies, such as UMTS and LTE, and further understand that the aspects disclosed herein are equally applicable to any such similar wireless technology.

Often, the femto access point will include multiple radios with which it may communicate. For communications with a UE that will be a part of the wireless communication network, the femto access point may communicate using an in-band communication link, such as a wireless wide area network (WWAN) link over a frequency which may or may not be the same frequency that a macro access point on the network will use for communications. A femto access point may also include short-range communications capabilities for out-of-band (OOB) signals and transmissions including OOB radios such as BLUETOOTH®, BLUETOOTH® Low Energy (LE), WIFI™ (standardized through IEEE 802.11), WIFI DIRECT™, ZIGBEE™, IEEE 802.15, and the like. Because modern UEs also generally include multiple radios in addition to WWAN radios for communication using the OOB protocols, a UE may also be able to establish communication with a femto access point using these OOB radios in addition to the UE's WWAN in-band communication capabilities.

In operation, some femto access points that include OOB capabilities may be referred to as femto OOBs or femto OOB access points, which could include a femto access point that also has an associated OOB radio component. Another implementation of a femto OOB could be an integrated femto OOB, such as an integrated femto WIFI™ (IFW) in which a WIFI™ radio is integrated into the same physical femto access point component. Another implementation of a femto OOB may be where the OOB access point is attached as a universal serial bus (USB) attachment or dongle to the femto access point or vice versa. In yet another embodiment of a femto OOB, the femto access points may be associated with an OOB access point in the sense that they belong to the same user, are physically proximate, and are usually in the same subnet. This can be treated as a virtual integrated femto OOB. The OOB radios for such femto OOBs may include BLUETOOTH®, BLUETOOTH® LE, WIFI™, WIFI DIRECT™, ZIGBEE™, IEEE 802.15, and the like.

Access to femto access points may be closed to all non-closed subscriber group (CSG) members, open for access to any UE, or could be a hybrid, with access to both members and non-members of the CSG. Before making a handover decision to handover a UE to an accessible target femto access point, a macro access point examines measurement information regarding the target femto access point and its access control mechanism. However, it would be impractical for a UE to take continuous measurements of every femto access point on its CSG whitelist and read the system information of those CSG coverage areas that it encounters, especially when the femto access point is on a different frequency than the macro frequency as that would involve inter-frequency measurements.

The co-pending, co-owned related application Serial Number ______, entitled, PROXIMITY INDICATION USING OUT-OF-BAND LINK, Attorney Docket Number 111686U1, describes detecting proximity to the femto access point using out-of-band (OOB) link capabilities (e.g., BLUETOOTH®, BLUETOOTH® LE, WIFI DIRECT™, ZIGBEE™, IEEE 802.11, IEEE 802.15, and the like) of certain UEs and femto access points. When a UE discovers that it is within the fingerprint area associated with the femto access point, instead of immediately reporting the proximity indication for the corresponding femto access point, the UE triggers femto access point detection using the OOB link. The fingerprint area is defined by the union of a set of neighbor macro coverage areas around the CSG/hybrid femto OOB access point of interest. Upon detecting the femto access point over the OOB link, the UE determines itself to be in proximity to the femto access point and transmits the proximity indication to its serving macro access point. In UMTS systems in Release 99, the UE would transmit this proximity indication to its serving radio network controller (RNC) through its macro access point, while in other systems, such as LTE systems, the UE would transmit the proximity indication only to the serving macro access point. As the femto OOB coverage is almost matched to the femto coverage, detection of the femto access point over the OOB link is a very precise and reliable mechanism for triggering transmission of the proximity indication.

Referring again to FIG. 1, femto access points 106-107 comprise femto access points or home NBs (HNBs) deployed within wireless network 10 creating femto coverage areas 109 and 110, respectively. UEs 112-114 are also illustrated within wireless network 10. In an existing proximity detection method, a home area is defined by macro coverage areas that are known neighbors of the target femto access point. For example, for purposes of the aspect illustrated in FIG. 1, femto access point 106 and femto coverage area 109 are a femto access point and home coverage area of UE 112. Therefore, according to the existing proximity determination schemes, the home area, also sometimes referred to as a fingerprint, may be defined as the combined area of macro coverage areas 100-102. UE 112 saves identifying information of macro coverage areas 100-102 in a proximity database (PD) for use in proximity detection of the femto access point, femto access point 106. Thus, in such existing proximity detection schemes, each time UE 112 moves into a location in which one of macro access points 103-105 becomes the strongest access point or is a member of its active set, UE 112 transmits a proximity indication, indicating proximity to the femto access point 106, to its serving RNC via the macro access point, such as macro access point 105. Additionally, the UE 112 will also store the femto access point-related identification information, including the radio access technology (RAT), frequency, femto access point ID, femto primary scrambling code (PSC), femto public land mobile network (PLMN) ID, and the like, in a femto access point search information database (SID).

FIG. 3 is a block diagram illustrating a detail of UE 112 configured according to one aspect of the present disclosure. UE 112 includes a wireless wide area network (WWAN) radio component 300 and also OOB radio components 301. OOB radio components 301 may include multiple different radios, OOB radios 301-1-301-N, for various wireless technologies, such as BLUETOOTH®, BLUETOOTH® LE, WIFI DIRECT™, ZIGBEE™, IEEE 802.15, global positioning system (GPS), and the like. Each of the radio components includes receivers, transmitters, antennas, and the like, used for sending and receiving transmissions over the WWAN and OOB protocols. For example, UE 112 detects macro coverage area 102 as a member of its active set over WWAN radio component 300. UE 112 then searches proximity database (PD) 304. PD 304 contains the details of the fingerprint area around the femto access points associated with UE 112, including the fingerprint surrounding the femto access point 106. As coverage area 102 is within this fingerprint area, UE 112 begins scanning for femto access point 106 using OOB radio components 301. UE 112 continues transmitting and receiving data over in-band WWAN link 305 with macro access point 105, if it is in a connected state, while scanning for the femto access point 106 over the OOB link 306 from femto access point 106 using OOB radio components 301.

Femto access point 106 has the capability for OOB transmissions. UE 112 detects the WIFI™ signals of femto access point 106 and is able to identify femto access point 106 from the WIFI™ signals received over WIFI™ OOB radio 301-1. UE 112 uses the WIFI™ identification information of femto access point 106 and matches this WIFI™ identification information to the WIFI™ identification information of femto access point 106 stored in femto access point SID 303 in memory 302. UE 112 uses relational mapping data in the femto access point SID 203 to map the WIFI™ identification information to the in-band/WWAN of the femto access point 106. After identifying the femto access point 106 using the information obtained based on detection over the OOB link 306, UE 112 transmits a proximity indication to the serving RNC via the macro access point 105. The handover evaluation process will then continue as before.

In order to detect proximity of a femto OOB access point though OOB signaling, the mobile (UE, MS, AT etc.) will be scanning multiple channels for OOB identifiers/signals associated with the femto OOB access point. Channel scanning is a time-consuming process. If conducting passive scanning, the UE would wait for several beacon intervals per channel in order to detect the femto OOB access point. Active scanning, in which the UE sends a probe request for a WIFI™ access point, may also be performed. Active scanning may take up to 15 msec per channel. The energy consumption on UE for passive scanning will be different than for active scanning.

A scanning method for femto OOB access points is described in which two types of scans may be performed. In a first type of scan, a list of femto OOB access points is generated along with their identifiers (e.g., SSID for WIFI™, channel of operation, MAC address for WIFI™, BLUETOOTH™ address (BD_ADDR), etc.) based on probe responses received in response to the first type of scan during or after the discovery of femto OOB access points. It is to be noted that a targeted active scan is not conducted for the first scan type as the UE does not know the OOB identification information of the target femto OOB access point. In this first type of scan, no proximity information is determined to assist in proximity indication reporting and the information from the first type of scan is used to populate the SID in the UE with information about the OOB link of the femto OOB access point. The non-OOB-related information related to the femto access point is assumed to be populated earlier or at the same time from the in-band link. The first scan type is generally carried out once for each femto OOB access point unless some OOB parameter, such as channel of operation, is changed.

The second type of scan may be initiated by a trigger (e.g., the mobile detects it is in the fingerprint area associated with the femto OOB access points, expiration of an offset time after entering the fingerprint area, entering an enhanced fingerprint area, in which the enhanced fingerprint area is defined by the intersection of a set of neighbor macro coverage areas around the CSG/hybrid femto OOB access point of interest, or the like). Once triggered, the UE actively scans the channels on which femto OOB access points on the list have been identified. When the UE receives responses to the second type of scan, it will report a proximity indication for the femto OOB access point to a serving radio network controller (RNC) through a base station using in-band signals over WWAN.

FIG. 4 is a functional block diagram illustrating example blocks executed to implement a first type of scan configured according to one aspect of the present disclosure. In block 400, a UE discovers a CSG/hybrid femto access point for the first time. In response to this first time discovery, in block 401, the UE populates the PD with the fingerprint information associated with the femto access point and also populates the SID with the relevant femto access point information. The UE will then attempt to determine whether the femto access point is a femto OOB access point. In block 402, the UE either transmits probe requests (if active scanning is used) or listens for beacon frames (if passive scanning is used) on each of the OOB channels, one after another. A determination is made, in block 403, whether the UE has received a response, whether a probe response or a beacon. If no such response is received, then, in block 404, the UE infers that the CSG/hybrid femto access point is not OOB-enabled. However, even if a beacon or probe response is received, the UE may not know if the femto access point is OOB-enabled or not, as those beacons or probe responses could have originated from OOB access points proximate to the femto access point.

Co-pending, commonly-owned related application Ser. No. 13/399,404, Attorney Docket Number 111686U1, entitled, PROXIMITY INDICATION USING OUT-OF-BAND LINK, describes multiple methods for obtaining OOB identification information regarding the CSG/hybrid femto access point and mapping this femto OOB information with the femto in-band information. This mapped relationship is then stored in the SID to assist in determining whether the probe response or beacon received is actually from the CSG/hybrid femto access point. Utilizing technology disclosed in this related application, in block 405, the UE infers mapping information between the CSG/hybrid femto access point's in-band and OOB identifiers. The UE then updates the SID, in block 406, with the OOB identification information, channel, and the like, of the femto OOB access point. As noted in block 402, this scanning procedure is repeated for all OOB channels to identify all OOB access points.

It should be noted that if the current standards provided such a mechanism, the UE would be able obtain this information about the OOB capability of the femto access point from the femto access point itself, using the in-band link. However, such OOB capability reporting over in-band link is not currently provided for in the existing standards and would require standards modification.

It should be further noted that there may be a latency during this initial discovery process; however, this latency should only be experienced during the first time scanning of the CSG/hybrid femto access point.

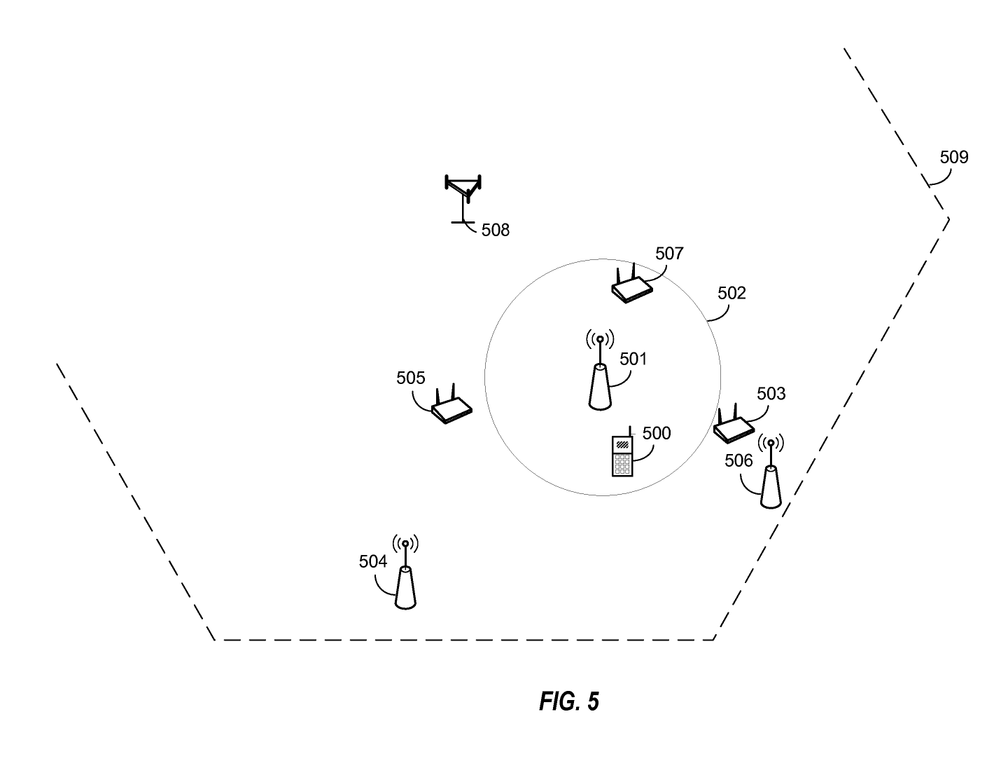

FIG. 5 is a block diagram illustrating a UE 500 configured according to one aspect of the present disclosure. UE 500 is in communication using in-band signals over the WWAN with macro access point 508. The UE 500 detects a femto access point, such as femto OOB access point 501, through normal procedures and determines if it is OOB-enabled or not, as described in FIG. 4. If femto OOB access point 501 is OOB-enabled then UE 500 determines the mapping between in-band and OOB identification information of the femto OOB access point, as described in FIG. 4. UE 500 begins the first scan type by transmitting probe requests (active scanning) or listening for beacons (passive scanning) in the OOB channels. As provided in the example illustrated in FIG. 5, UE 500 receives probe responses or beacons from femto OOB access points 501, 504, and 506, and from OOB access points 503, 505, and 507. As these probe responses or beacons are received, UE 500 determines whether the responses are from a femto OOB access point, using technology described in the co-pending, commonly-owned related application Ser. No. 13/399,404, Attorney Docket Number 111686U1 entitled, PROXIMITY INDICATION USING OUT-OF-BAND LINK. In other embodiments, without such technologies in the related application, UE 500 might not be able to determine if the probe responses or beacons originate from femto OOB access point, from neighboring OOB access points, or even from neighboring femto OOB access points. It should be noted that OOB access points 503, 505, and 507 may also utilize OOB technologies, such as BLUETOOTH®, BLUETOOTH® LE, WIFI DIRECT™, ZIGBEE™, IEEE 802.15, and the like.

After performing the first type of scan, UE 500 has its SID populated and updated with the OOB identification information for femto OOB access points 501, 504, and 506. Thus, when UE 500 leaves the area and returns for subsequent visits, a first scan type would not typically be required. During subsequent visits to CSG/hybrid femto access points, UE 500 would begin the second scan type if it determines that it is within the fingerprint area associated with the femto OOB access point, as described in the co-pending, commonly-owned related application Ser. No. 13/399,404, Attorney Docket Number 111686U1 entitled, PROXIMITY INDICATION USING OUT-OF-BAND LINK.

As illustrated in FIG. 5, UE 500 includes fingerprint area 509 related to femto OOB access point 501. Information regarding this fingerprint area 509 are stored in the PD of UE 500. As UE 500 detects its entry into fingerprint area 509, a second scan type is triggered. UE 500 transmits directed probe requests or attempts to receive beacons on the OOB channels, as stored in the SID for that femto OOB access point during the first visit of UE 500 to that particular femto OOB access point. If sending a directed probe request, UE 500 will use the corresponding OOB identification information of the femto OOB access point as stored in the SID. For example, on subsequent visits to femto OOB access point 501, when UE 500 determines that it is within fingerprint area 509 of femto access point 501, UE 500 will send a probe request that may include the MAC address of femto OOB access point 501 in the ID field of the probe.

If there are multiple CSG/hybrid femto OOB access points in the PD that UE 500 is looking for in a given fingerprint area, and they happen to operate in the same OOB channel, the UE 500 transmits a broadcast probe request with a broadcast address as the destination and broadcast ID information on that channel. For example, within fingerprint area 509, the PD of UE 500 may indicate that femto OOB access point 501 and femto OOB access point 506 operate in the same OOB channel. Therefore, UE 500 would transmit a broadcast probe request with a broadcast address and broadcast OOB ID on the channel in which both femto OOB access points 501 and 506 operate.

However, for simplicity of description, FIG. 5 considers only that femto OOB access point 501 is in the CSG whitelist of UE 500, and, therefore, UE 500 is looking specifically for femto OOB access point 501. Thus, UE 500 will send directed probe requests on the specific OOB channels configured for the femto OOB access point 501. When the UE 500 receives a response to the probe requests from femto OOB access point 501, the UE 500 transmits a proximity indication associated with femto OOB access point 501 to serving RNC via macro access point 508 using in-band communication signals on the WWAN. Macro access point 508 may then direct UE 500 to report measurements for femto OOB access point 501 and use such measurements to determine whether to handover UE 500 to femto OOB access point 501 for service within femto coverage area 502.

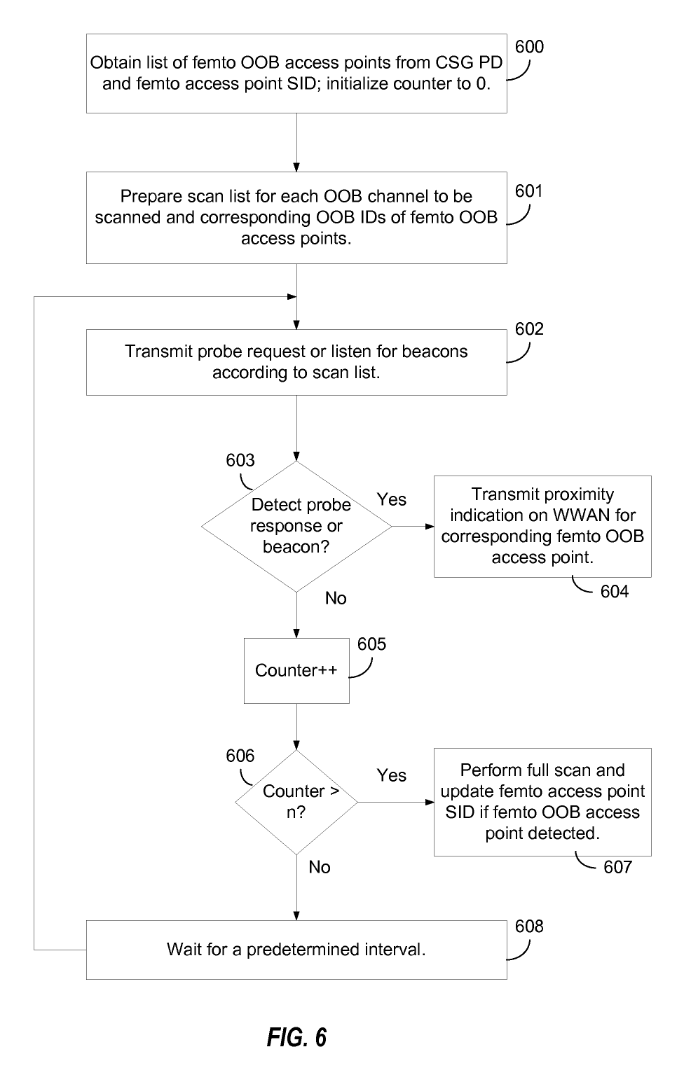

FIG. 6 is a functional block diagram illustrating example blocks executed to implement one aspect of the second scan type of the present disclosure. In block 600, a UE obtains a list of femto OOB access points from the CSG proximity database by comparing the current UE location with the stored fingerprint information in its proximity database (PD) and the femto access point search information database (SID), and also sets a counter to zero. Using this list, the UE prepares a scan list, in block 601, for each OOB channel to be scanned along with the corresponding OOB IDs to search associated with the femto OOB access points and other connection information.

In block 602, the UE transmits probe requests, if using active scanning, or listens for beacons, if using passive scanning, according to the scan list. A determination is made, in block 603, whether the UE detects responses from a femto OOB access point, whether a probe response or detecting a beacon. If a response is detected, then, in block 604, the UE transmits a proximity indication to the serving RNC on the WWAN for the corresponding femto OOB access point. If there is no response detected, then, in block 605, the counter is incremented. A determination is made, in block 606, whether the counter has exceeded a predetermined number. If so, then, in block 607, the UE performs a full scan and updates the femto access point SID with the OOB channel information and, if applicable, with the OOB IDs associated with the femto OOB access point. The full scan may include scanning to detect the femto OOB access point and, if any information about the OOB link of the femto OOB access point has changed, the femto access point SID is updated with new information.

It should be noted that the predetermined number to which the counter is compared may be based on a statistical number of searches used to result in a meaningful search. This statistical number may be related to the number of searches, in which searches performed in excess of that number of times would not significantly increase the probability of detecting the femto OOB access point over OOB. Such a failure to detect may be attributable to many factors, such as change in the OOB channel or change of the OOB ID. Thus, as described in block 607, when this predetermined number is exceeded, a full scan would be performed to update the SID with any information that may have changed. This may also depend on the size of the fingerprint area compared to the femto access point coverage area, which may sometimes be referred to as the fingerprint footprint.

If the counter has not yet exceeded the predetermined number, then, the UE waits a predetermined interval, in block 608, before retransmitting the probe request in block 602. It should be noted that the predetermined interval may be based on the operating system of the UE, configured according to the fingerprint footprint, and the like.

It should be noted that, in various aspects of the present disclosure, the second type of scanning may be triggered by the UE detecting entry into its fingerprint area. For example, with reference to FIG. 5, when UE 500 determines that it is located in the fingerprint area 509, it begins transmitting the probe requests of the second scan type according to the scan list. In another example aspect, the second scan type may be triggered by a time offset. For example, also with reference to FIG. 5, after UE 500 detects that it has entered the fingerprint area 509, a timer is started to count off the time offset. When the time offset has been reached, the UE 500 triggers the second scan type.

It should be noted that the time offset value may be determined based on how large the fingerprint area is compared to the femto OOB access point coverage (in-band and OOB coverage). For example, if the fingerprint area is large, scans could be wasted if UE 500 starts the scan immediately after entering fingerprint area 509 where UE 500 has not yet entered the femto OOB access point coverage area 502. As UE 500 learns more about the relationship between the fingerprint area 509 and the coverage area 502 of the femto OOB access point 501, it may optimize the value of time offset over time.

It should further be noted that a time offset may also be used during proximity indication reporting without OOB signaling. In another separate example aspect, with reference back to FIG. 5, during the first scan type, UE 500 determines and infers that femto OOB access point 501, in fact, does not have OOB signaling capabilities. Such lack of capabilities may be due to failure of the OOB elements of femto OOB access point 501 or simply, in this additional example, femto OOB access point 501 does not have OOB-capabilities. Thus, on subsequent visits to the area, as UE 500 would know that femto OOB access point 501 does not have OOB capability. When UE 500 detects entry into fingerprint area 509 knowing that femto OOB access point 501 does not have OOB capabilities, instead of immediately transmitting a proximity indication to the serving RNC using in-band signals through macro access point 508, UE 500 starts a timer (not shown). When the timer has reached the timing offset, UE 500 then transmits the proximity indication to the serving RNC using in-band signals through macro access point 508. The size of the time offset may be determined as previously discussed, based on the fingerprint footprint or the size of fingerprint area 509 in relation to the femto OOB access point coverage area 502.

It should further be noted that a time offset may be used by a UE during current methods of proximity detection without OOB scans performed according to the first or second scan types. In such example aspects, with reference again to FIG. 5, when UE 500 detects entry to fingerprint area 509, in current standard operation of proximity detection, UE 500 would transmit the proximity indication to the serving RNC. However, in this example aspect, when UE 500 detects entry into fingerprint area 509, a timer is started. When the timer reaches the predetermined time offset, the UE 500 will then transmit the proximity indication to the serving RNC using in-band signals through the macro access point 508. This predetermined time offset may be determined as previously described, with consideration to the relationship between the fingerprint area 509 and the femto OOB access point coverage area 502.

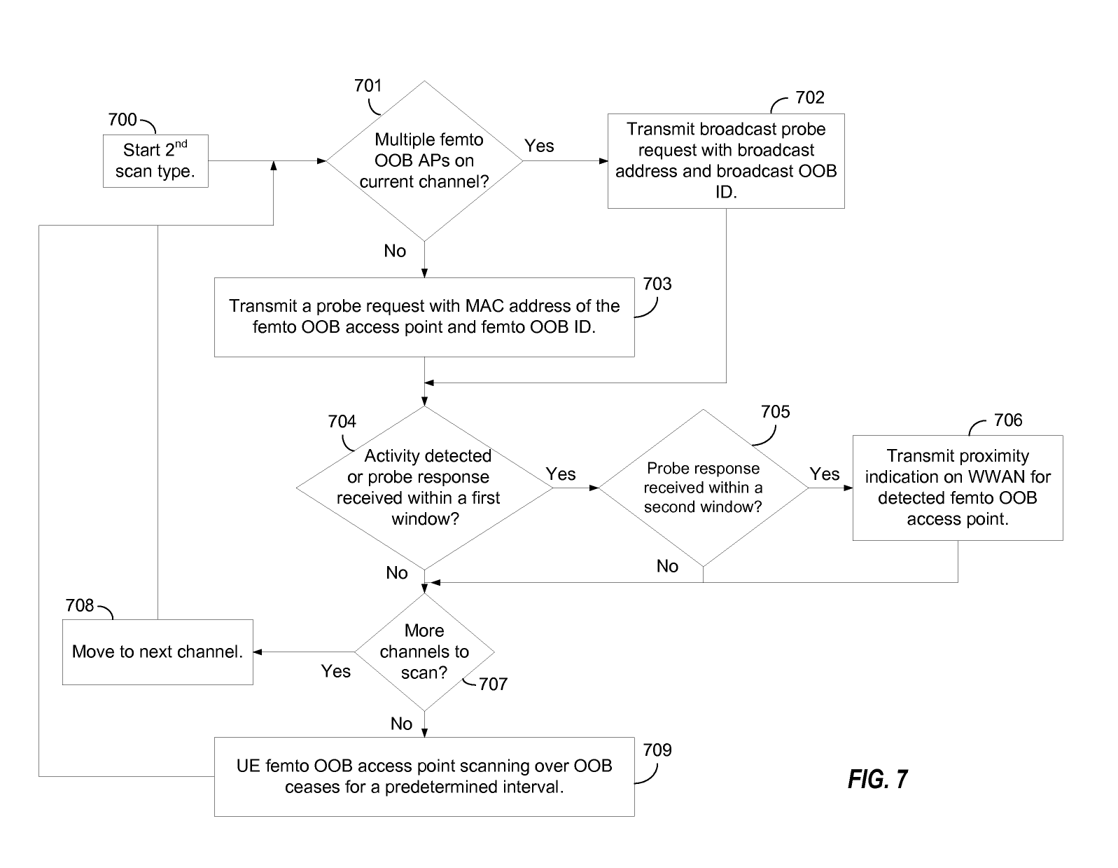

FIG. 7 is a functional block diagram illustrating detailed blocks executed to implement the second type of scan configured according to one aspect of the present disclosure. In block 700, the UE starts the second type of scan. In selected aspects, block 700 is triggered when the UE detects that it is within a first proximity of the femto access point, such as a fingerprint area surrounding a target femto OOB access point, or after the expiration of a time offset after entering the fingerprint area, or the like. At this point, the UE would have already (1) performed the first type of scan; (2) populated the CSG PD and femto access point SID with relevant fingerprint and femto OOB access point information; and (3) generated the scan list from CSG PD and femto access point SID.

A determination is made, in block 701, whether the scan list provides for multiple femto OOB access points on the current, single OOB channel. If so, then, in block 702, the UE transmits a broadcast probe request with broadcast address and broadcast OOB ID. However, if there is only a single femto OOB access point in the OOB channel to be scanned, then, in block 703, the UE transmits a probe request with the MAC address of the femto OOB access point and the femto OOB ID in the ID field of the probe. It should be noted that the UE may also transmit a broadcast probe request when only a single femto access point is indicated for that OOB channel. The various aspects of the disclosure are not limited in scope to a single method for transmitting the probe requests.

In block 704, a determination is made whether any activity is detected within a first time window. For example, if no probe response is received but some activity is detected by a first window or minimum time period, the UE will wait until a second window or maximum time period to receive a probe response. In block 705, a determination is made whether a probe response associated with a femto OOB access point on the UE's CSG whitelist has been received before the expiration of the second window. If so, then, in block 706, the UE transmits a proximity indication to its serving RNC via the macro access point on the WWAN for the detected femto OOB access points. However, if no activity is detected by the first window, as determined in block 704, or the UE does not receive any probe responses by expiration of the second window, as determined in block 705, then, in block 707, a determination is made whether there are more channels to scan in the scan list. If so, then, in block 708, the UE moves to the next channel and continues the scan process from block 701. If all of the channels to be scanned have been scanned, then, in block 709, the UE will stop scanning for femto access points for a predetermined interval.

As noted previously, a UE may perform the first type of scan to generate the CSG proximity list of potential femto OOB access points and then wait to perform the second type scan during subsequent visits when a certain second scan type event trigger occurs. For example, one trigger may be the UE entry into the fingerprint area around a known femto access point. Turning back to FIG. 1, UE 112 performs the first type of scan when it discovers the femto access point for the first time. During subsequent visits, when UE 112 detects macro access point 105 of macro coverage area 102 in its active list, it knows that it has entered its fingerprint area and triggers the second scan type. In another example aspect of the disclosure, the UE may trigger the second scan type when it detects entry into an enhanced fingerprint area.

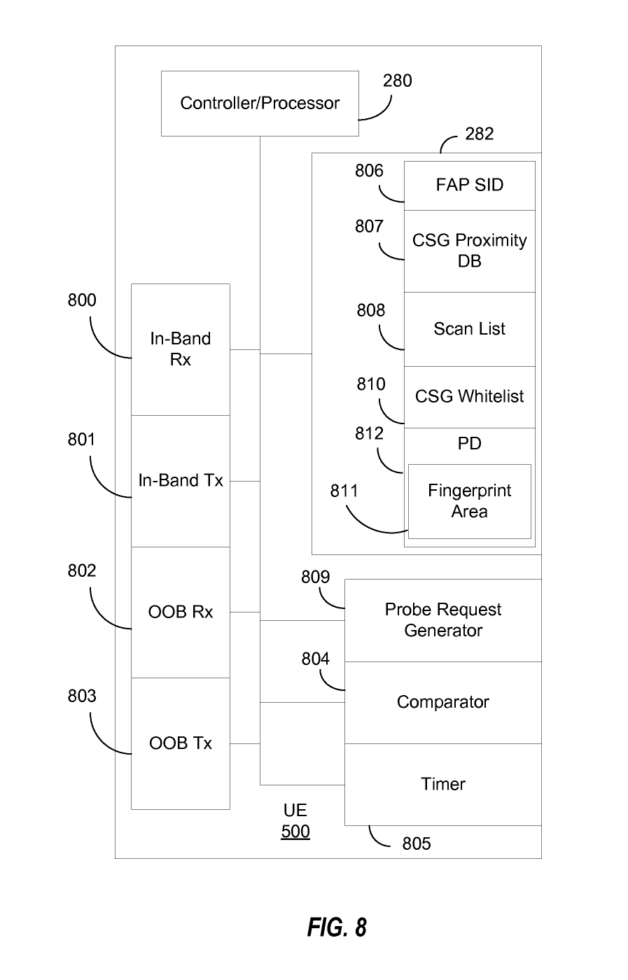

FIG. 8 is a block diagram illustrating a detail of a UE 500 configured according to one aspect of the present disclosure. UE 500 includes a controller/processor 280 and a memory 282 coupled to the controller/processor 280. Memory 282 provides computer-readable storage of code and electronic information, which, when executed and used by controller/processor, controls and executes the code instructions that provide the various features and functionality of UE 500. Under control of controller/processor 580, in-band receiver 800, in-band transmitter 801, OOB receiver 802, and OOB transmitter 803, provide communication of data and control signals and information over in-band WWAN transmission frequencies and OOB transmission frequencies, such as in connection with BLUETOOTH®, WIFI™, and the like.

In preparation for proximity detection using an active scan in OOB radio communications, controller/processor 280 executes code from memory 282 that operates the functionality of probe request generator 809. Probe request generator 809 generates probe requests directed to discover any femto OOB access points in the radio range of UE 500. Under control of controller/processor 280, probe request generator 809 provides probe requests for transmission by OOB transmitter 803. Controller/processor 280 causes OOB transmitter 803 to send the probe requests over each available OOB channel. When preparing for proximity detection using a passive scan, the controller/processor 280 controls and monitors OOB receiver 802 to listen for beacon frames on the OOB channels. The combination of these components provides means for performing a first scan type, by a mobile device, over multiple OOB channels for OOB signals associated with the CSG/hybrid femto access point, wherein the first scan type is performed in response to detecting the CSG/hybrid femto access point for a first time over an in-band channel.

UE 500 waits to receive any responses, whether they are to the probe requests or detection of beacons through OOB receiver 802. When responses are received, controller/processor 280 accesses femto access point information from the femto access point SID 806 stored in memory 282 and uses comparator 804 to determine whether the probe responses originate from femto OOB access points. The combination of these components provides means for determining whether one or more first OOB responses originate from a femto OOB access point, wherein the one or more first OOB responses are detected in response to the first scan type.

As the results from the comparator 804 showing whether the probe responses came from femto OOB access points, the controller/processor 280 creates mapping information that maps the OOB identification information, channel, and the like, of the femto OOB access point to the in-band identifiers associated with the femto OOB access point. These components of UE 500 provide means for generating mapping information mapping one or more OOB identifiers associated with the femto OOB access point with one or more in-band identifiers associated with the femto OOB access point in response to determining the one or more first OOB responses originate from the femto OOB access point.

Once the mapping information is created, controller/processor 280 updates the femto access point SID 806 in memory 282 with the mapping information. The combination of these components provides means for updating a search database stored on the mobile device with the mapping information.

After performing the first scan type, the UE 500 has updated OOB information about the femto OOB access points. On subsequent visits to the location of the femto OOB access points, UE 500 may, instead perform a second scan type to determine proximity information when UE detects that it has entered the fingerprint area associated with the femto OOB access point. Controller/processor 280 monitors in-band signals over in-band receiver 800 and compares those signals with comparator 804 against the fingerprint area information 811 of PD 812, stored in memory 282. Based on that comparison, UE 500 determines whether it has entered its fingerprint area in order to trigger the second scan type. In active scanning aspects, when UE 500 enters its fingerprint area associated with the femto OOB access point, the controller/processor 280 controls the probe request generator 809 to transmit probe requests over OOB transmitter 803. Probe request generator 809 may generate individually targeted probe requests or broadcast probe requests depending on whether the information stored in scan list 808 indicates that one or more potential femto OOB access points operates on the same channel. Controller/processor 280 causes OOB transmitter 803 to transmit the appropriate probe requests only over those channels indicated in the scan list 808 for potential femto OOB access points. In passive scanning aspects, when UE 500 enters its fingerprint area associated with the femto OOB access point, the controller/processor 280 controls the OOB receiver 802 to listen for beacons on the identified OOB channels. These components provide means for performing a second scan type over one or more OOB channels associated with one or more femto OOB access points identified in a search database stored on the mobile device.

Controller/processor 280 monitors OOB receiver 802 to receive responses to the second type of scan, either probe responses, in active scan aspects, or detected beacons, in passive scan aspects. The combination of these components provides means for receiving one or more responses in response to the second scan type.

Controller/processor 280 determines whether the received responses are from femto OOB access points. If so, then controller/processor 280 causes a proximity indication to be transmitted to the serving RNC through in-band signals transmitted by in-band transmitter 801 through the serving base station. The combination of these components provides means for reporting a proximity indication over an in-band link, wherein the proximity indication indicates proximity of the mobile device to one or more responding femto OOB access points from which the one or more responses are received.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 4, 6, and 7 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both non-transitory computer storage media and communication media including any medium that facilitates transfer of a computer program from one place to another. A storage media may be any available media that can be accessed by a general purpose or special purpose computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of scanning for a closed subscriber group (CSG)/hybrid femto access point, comprising:
performing a first scan type, by a mobile device, over a plurality of out-of-band (OOB) channels for OOB signals associated with the CSG/hybrid femto access point, wherein the first scan type is performed in response to detecting the CSG/hybrid femto access point for a first time over an in-band channel;
determining, at the mobile device, whether one or more OOB responses originate from a femto OOB access point, wherein the one or more OOB responses are detected in response to the first scan type;
generating, by the mobile device, mapping information mapping one or more OOB identifiers associated with the femto OOB access point with one or more in-band identifiers associated with the femto OOB access point in response to determining the one or more OOB responses originate from the femto OOB access point; and
updating a search database stored on the mobile device with the mapping information.

2. The method of claim 1, wherein the first scan type comprises:
transmitting a probe request frame on each OOB channel of the plurality of OOB channels containing a broadcast address as a destination and a broadcast identifier (ID) as the OOB ID;
starting a probe timer;
listening for the one or more OOB responses;
scanning a next OOB channel of the plurality of OOB channels, when one of:
the one or more OOB responses to the transmitted probe request are received on the OOB channel by a minimum channel time determined by the probe timer;
no activity is detected on the OOB channel by a minimum channel time; or
activity is detected on the OOB channel by the minimum channel time and one of:
no probe response is received on the OOB channel by a maximum channel time; or
the one or more OOB responses are received on the OOB channel by a maximum channel time.

3. The method of claim 2, further comprising:
determining that the CSG/hybrid femto access point is not the femto OOB access point when no probe response is received on any of the plurality of OOB channels.

4. The method of claim 1, wherein the first scan type comprises:
listening, by the mobile device, for a beacon on each OOB channel of the plurality of OOB channels;
starting a scan timer; and
scanning a next OOB channel of the plurality of OOB channels on expiration of the scan timer.

5. The method of claim 4, further comprising:
determining that the CSG/hybrid femto access point is not the femto OOB access point when no beacon is received on any of the plurality of OOB channels.

6. The method of claim 1, further comprising, in response to determination that the CSG/hybrid femto access point is not the femto OOB access point:
detecting, by a mobile device, in-band signaling indicating a location of the mobile device within one of:
a union; and
an intersection,
of a set of neighbor macro coverage areas around the CSG/hybrid femto access point;
starting a timer in response to the detecting; and
transmitting, over in-band signaling, a proximity indication to a serving base station when the timer reaches a predetermined time offset, wherein the proximity indication indicates the mobile device being proximate to the CSG/hybrid femto access point.

7. The method of claim 1, wherein the mapping information comprises one or more of:
OOB identification information; and
OOB channel of operation.

8. The method of claim 1, further comprising:
performing a second scan type, by the mobile device, over one or more OOB channels associated with one or more femto OOB access points identified in the mapping information stored in the search database after performing the first scan type;
receiving, at the mobile device, one or more responses in response to the second scan type; and
reporting a proximity indication, by the mobile device, over an in-band link, wherein the proximity indication indicates proximity of the mobile device to one or more responding femto OOB access points from which the one or more responses are received.

9. The method of claim 8, wherein the second scan type is performed on visits to a coverage area of the CSG/hybrid femto access point subsequent to the performing the first scan type.

10. The method of claim 8, wherein the second scan type is performed after determining a location of the mobile device within one of:
a union; and
an intersection,
of a set of neighbor macro coverage areas around the CSG/hybrid femto OOB access point.

11. A method of scanning for a closed subscriber group (CSG)/hybrid femto access point, comprising:
performing a second scan type, by a mobile device, over one or more out-of-band (OOB) channels associated with one or more femto OOB access points identified in a search database stored on the mobile device;
receiving, at the mobile device, one or more responses in response to the second scan type; and
reporting a proximity indication, by the mobile device, over an in-band link, wherein the proximity indication indicates proximity of the mobile device to one or more responding femto OOB access points from which the one or more responses are received.

12. The method of claim 11, wherein the second scan type comprises:
listening, by the mobile device, for a beacon on each OOB channel of the one or more OOB channels associated with the one or more femto OOB access points;
starting a scan timer; and
scanning a next OOB channel of the one or more OOB channels on expiration of the scan timer.

13. The method of claim 11, wherein the second scan type comprises:
transmitting a probe request on each OOB channel of the one or more OOB channels associated with the one or more femto OOB access points;
starting a probe timer;
listening for one or more probe responses on each of the one or more OOB channels; and
transmitting the probe request on a next OOB channel of the one or more OOB channels on expiration of the probe timer.

14. The method of claim 11, wherein the second scan type is performed after an in-band determination of a location of the mobile device within one of:
a union; and
an intersection,
of a set of neighbor macro coverage areas around the CSG/hybrid femto OOB access point.

15. The method of claim 14, further comprising:
delaying performance of the second scan type after expiration of a predetermined time offset, wherein the predetermined time offset begins in response to the in-band determination of the location of the mobile device.

16. The method of claim 15, wherein the predetermined time offset is based, at least in part, on a relationship between a fingerprint coverage area defined by one of: the union and the intersection, of the set of neighbor macro coverage areas and a femto coverage area of the CSG/hybrid femto OOB access point.

17. The method of claim 11, further comprising:
resetting a counter after receiving a list of the one or more femto OOB access points for the search database, wherein the list includes OOB identification information associated with the one or more femto OOB access points;
incrementing the counter when no responses are received in response to the second scan type;
comparing the incremented counter with a predetermined number;
re-performing the second scan type after a predetermined time interval in response to the incremented counter not exceeding the predetermined number; and
performing a full scan to update the list in response to the incremented counter exceeding the predetermined number.

18. The method of claim 17, wherein the predetermined number is based on a number of second scan type searches, in which second scan type searches performed in excess of the number would not significantly increase the probability of detecting the one or more femto OOB access points over the one or more OOB channels.

19. The method of claim 17, wherein the OOB identification information includes one or more of:
channel of operation; and
OOB identifier.

20. The method of claim 11, further comprising:
starting a timer, when the second scan type is performed on an OOB channel of the one or more OOB channels;
listening for the one or more responses;
performing the second scan type on a next OOB channel of the one or more OOB channels, when one of:
the one or more responses to the second scan type are received on the OOB channel by a first time window determined by the timer;
no activity is detected on the OOB channel by the first time window; or
activity is detected on the OOB channel by the minimum channel time and one of:
no probe response is received on the OOB channel by a maximum channel time; or
the one or more probe responses are received on the OOB channel by a maximum channel time.

21. The method of claim 14, further comprising, for each OOB channel of the one or more OOB channels on which a plurality of femto OOB access points of the one or more femto OOB access points is associated, as identified in the search database:
transmitting a broadcast probe having a broadcast address and broadcast OOB identifier.

22. The method of claim 21, further comprising:
receiving a probe response to the broadcast probe; and
determining, prior to reporting the proximity indication, which one of the plurality of femto OOB access points on the each OOB channel transmitted the received probe response.

23. The method of claim 11, further comprising:
prior to the performing the second scan type, performing a first scan type, by the mobile device, wherein the first scan type identifies the one or more femto OOB access points, associates the one or more OOB channels to the identified one or more femto OOB access points, and stores identification of the one or more femto OOB access points and the associated one or more OOB channels to the search database on the mobile device.

24. The method of claim 23, wherein performing the first scan type comprises:
performing the first scan type over a plurality of out-of-band (OOB) channels for OOB signals associated with the CSG/hybrid femto access point, wherein the first scan type is performed in response to detecting each of the one or more femto OOB access points for a first time over an in-band channel;
determining, at the mobile device, whether one or more OOB responses originate from a femto OOB access point, wherein the one or more OOB responses are detected in response to the first scan type;
generating, by the mobile device, mapping information mapping one or more OOB identifiers associated with the femto OOB access point with one or more in-band identifiers associated with the femto OOB access point in response to determining the one or more OOB responses originate from the femto OOB access point; and
updating the search database stored on the mobile device with the mapping information.

25. The method of claim 24, wherein the mapping information comprises one or more of:
OOB identification information; and
OOB channel of operation.

26. A method of reporting proximity to a closed subscriber group (CSG)/hybrid femto access point, comprising:
detecting, by a mobile device, a location of the mobile device within at least one neighbor macro coverage areas around the CSG/hybrid femto access point;
starting a timer in response to the detecting; and
transmitting, over in-band signaling, a proximity indication to a serving base station when the timer reaches a predetermined time offset, wherein the proximity indication indicates the mobile device being proximate to the CSG/hybrid femto access point.

27. The method of claim 26, wherein the predetermined time offset is based, at least in part, on a relationship between a fingerprint coverage area defined by one of: a union and the intersection, of a plurality of neighbor macro coverage areas and a femto coverage area of the CSG/hybrid femto access point.

28. An apparatus of scanning for a closed subscriber group (CSG)/hybrid femto access point, comprising:
means for performing a first scan type, by a mobile device, over a plurality of out-of-band (OOB) channels for OOB signals associated with the CSG/hybrid femto access point, wherein the first scan type is performed in response to detecting the CSG/hybrid femto access point for a first time over an in-band channel;
means for determining, at the mobile device, whether one or more OOB responses originate from a femto OOB access point, wherein the one or more OOB responses are detected in response to the first scan type;
means for generating, by the mobile device, mapping information mapping one or more OOB identifiers associated with the femto OOB access point with one or more in-band identifiers associated with the femto OOB access point in response to determining the one or more OOB responses originate from the femto OOB access point; and
means for updating a search database stored on the mobile device with the mapping information.

29. The apparatus of claim 28, wherein the first scan type comprises:
means for transmitting a probe request frame on each OOB channel of the plurality of OOB channels containing a broadcast address as a destination and a broadcast identifier (ID) as the OOB ID;
means for starting a probe timer;
means for listening for the one or more OOB responses;
means for scanning a next OOB channel of the plurality of OOB channels, when one of:
the one or more OOB responses to the transmitted probe request are received on the OOB channel by a minimum channel time determined by the probe timer;
no activity is detected on the OOB channel by a minimum channel time; or
activity is detected on the OOB channel by the minimum channel time and one of:
no probe response is received on the OOB channel by a maximum channel time; or
the one or more OOB responses are received on the OOB channel by a maximum channel time.

30. The apparatus of claim 29, further comprising:
means for determining that the CSG/hybrid femto access point is not the femto OOB access point when no probe response is received on any of the plurality of OOB channels.

31. The apparatus of claim 28, wherein the first scan type comprises:
means for listening, by the mobile device, for a beacon on each OOB channel of the plurality of OOB channels;
means for starting a scan timer; and
means for scanning a next OOB channel of the plurality of OOB channels on expiration of the scan timer.

32. The apparatus of claim 31, further comprising:
means for determining that the CSG/hybrid femto access point is not the femto OOB access point when no beacon is received on any of the plurality of OOB channels.

33. The apparatus of claim 28, further comprising, in response to determination that the CSG/hybrid femto access point is not the femto OOB access point:
means for detecting, by a mobile device, in-band signaling indicating a location of the mobile device within one of:
a union; and
an intersection,
of a set of neighbor macro coverage areas around the CSG/hybrid femto access point;
means for starting a timer in response to the detecting; and
means for transmitting, over in-band signaling, a proximity indication to a serving base station when the timer reaches a predetermined time offset, wherein the proximity indication indicates the mobile device being proximate to the CSG/hybrid femto access point.

34. The apparatus of claim 28, wherein the mapping information comprises one or more of:
OOB identification information; and
OOB channel of operation.

35. The apparatus of claim 28, further comprising:
means for performing a second scan type, by the mobile device, over one or more OOB channels associated with one or more femto OOB access points identified in the mapping information stored in the search database after performing the first scan type;
means for receiving, at the mobile device, one or more responses in response to the second scan type; and
means for reporting a proximity indication, by the mobile device, over an in-band link, wherein the proximity indication indicates proximity of the mobile device to one or more responding femto OOB access points from which the one or more responses are received.

36. The apparatus of claim 35, wherein the second scan type is performed on visits to a coverage area of the CSG/hybrid femto access point subsequent to execution of the means for performing the first scan type.

37. The apparatus of claim 35, wherein the second scan type is performed after determining a location of the mobile device within one of:
a union; and
an intersection,
of a set of neighbor macro coverage areas around the CSG/hybrid femto OOB access point.

38. An apparatus of scanning for a closed subscriber group (CSG)/hybrid femto access point, comprising:
means for performing a second scan type, by a mobile device, over one or more out-of-band (OOB) channels associated with one or more femto OOB access points identified in a search database stored on the mobile device;
means for receiving, at the mobile device, one or more responses in response to the second scan type; and
means for reporting a proximity indication, by the mobile device, over an in-band link, wherein the proximity indication indicates proximity of the mobile device to one or more responding femto OOB access points from which the one or more responses are received.

39. The apparatus of claim 38, wherein the second scan type comprises:
means for listening, by the mobile device, for a beacon on each OOB channel of the one or more OOB channels associated with the one or more femto OOB access points;
means for starting a scan timer; and
means for scanning a next OOB channel of the one or more OOB channels on expiration of the scan timer.

40. The apparatus of claim 38, wherein the second scan type comprises:
means for transmitting a probe request on each OOB channel of the one or more OOB channels associated with the one or more femto OOB access points;
means for starting a probe timer;
means for listening for one or more probe responses on each of the one or more OOB channels; and
means for transmitting the probe request on a next OOB channel of the one or more OOB channels on expiration of the probe timer.

41. The apparatus of claim 38, wherein the second scan type is performed after an in-band determination of a location of the mobile device within one of:
a union; and
an intersection,
of a set of neighbor macro coverage areas around the CSG/hybrid femto OOB access point.

42. The apparatus of claim 41, further comprising:
means for delaying performance of the second scan type after expiration of a predetermined time offset, wherein the predetermined time offset begins in response to the in-band determination of the location of the mobile device.

43. The apparatus of claim 42, wherein the predetermined time offset is based, at least in part, on a relationship between a fingerprint coverage area defined by one of: the union and the intersection, of the set of neighbor macro coverage areas and a femto coverage area of the CSG/hybrid femto OOB access point.

44. The apparatus of claim 38, further comprising:
means for resetting a counter after receiving a list of the one or more femto OOB access points for the search database, wherein the list includes OOB identification information associated with the one or more femto OOB access points;
means for incrementing the counter when no responses are received in response to the second scan type;
means for comparing the incremented counter with a predetermined number;
means for re-performing the second scan type after a predetermined time interval in response to the incremented counter not exceeding the predetermined number; and
means for performing a full scan to update the list in response to the incremented counter exceeding the predetermined number.

45. The apparatus of claim 44, wherein the predetermined number is based on a number of second scan type searches, in which second scan type searches performed in excess of the number would not significantly increase the probability of detecting the one or more femto OOB access points over the one or more OOB channels.

46. The apparatus of claim 44, wherein the OOB identification information includes one or more of:
channel of operation; and
OOB identifier.

47. The apparatus of claim 38, further comprising:
means for starting a timer, when the second scan type is performed on an OOB channel of the one or more OOB channels;
means for listening for the one or more responses;
means for performing the second scan type on a next OOB channel of the one or more OOB channels, when one of:
the one or more responses to the second scan type are received on the OOB channel by a first time window determined by the timer;
no activity is detected on the OOB channel by the first time window; or
activity is detected on the OOB channel by the minimum channel time and one of:
no probe response is received on the OOB channel by a maximum channel time; or
the one or more probe responses are received on the OOB channel by a maximum channel time.

48. The apparatus of claim 41, further comprising, for each OOB channel of the one or more OOB channels on which a plurality of femto OOB access points of the one or more femto OOB access points is associated, as identified in the search database:
means for transmitting a broadcast probe having a broadcast address and broadcast OOB identifier.

49. The apparatus of claim 48, further comprising:
means for receiving a probe response to the broadcast probe; and
means for determining, prior to reporting the proximity indication, which one of the plurality of femto OOB access points on the each OOB channel transmitted the received probe response.

50. The apparatus of claim 38, further comprising:
means, executable prior to executing the means for performing the second scan type, for performing a first scan type, by the mobile device, wherein the first scan type identifies the one or more femto OOB access points, associates the one or more OOB channels to the identified one or more femto OOB access points, and stores identification of the one or more femto OOB access points and the associated one or more OOB channels to the search database on the mobile device.

51. The apparatus of claim 50, wherein means for performing the first scan type comprises:
means for performing the first scan type over a plurality of out-of-band (OOB) channels for OOB signals associated with the CSG/hybrid femto access point, wherein the first scan type is performed in response to detecting each of the one or more femto OOB access points for a first time over an in-band channel;
means for determining, at the mobile device, whether one or more OOB responses originate from a femto OOB access point, wherein the one or more OOB responses are detected in response to the first scan type;
means for generating, by the mobile device, mapping information mapping one or more OOB identifiers associated with the femto OOB access point with one or more in-band identifiers associated with the femto OOB access point in response to determining the one or more OOB responses originate from the femto OOB access point; and
means for updating the search database stored on the mobile device with the mapping information.

52. The apparatus of claim 51, wherein the mapping information comprises one or more of:
OOB identification information; and
OOB channel of operation.

53. An apparatus of reporting proximity to a closed subscriber group (CSG)/hybrid femto access point, comprising:
means for detecting, by a mobile device, a location of the mobile device within at least one neighbor macro coverage areas around the CSG/hybrid femto access point;
means for starting a timer in response to results of the means for detecting; and
means for transmitting, over in-band signaling, a proximity indication to a serving base station when the timer reaches a predetermined time offset, wherein the proximity indication indicates the mobile device being proximate to the CSG/hybrid femto access point.

54. The apparatus of claim 53, wherein the predetermined time offset is based, at least in part, on a relationship between a fingerprint coverage area defined by one of: the union and the intersection, of a plurality neighbor macro coverage areas and a femto coverage area of the CSG/hybrid femto access point.

55. A computer program product for wireless communications in a wireless network, comprising:
a non-transitory computer-readable medium having program code recorded thereon, the program code including:
program code to perform a first scan type, by a mobile device, over a plurality of out-of-band (OOB) channels for OOB signals associated with the CSG/hybrid femto access point, wherein the first scan type is performed in response to detecting the CSG/hybrid femto access point for a first time over an in-band channel;
program code to determine, at the mobile device, whether one or more OOB responses originate from a femto OOB access point, wherein the one or more OOB responses are detected in response to the first scan type;
program code to generate, by the mobile device, mapping information mapping one or more OOB identifiers associated with the femto OOB access point with one or more in-band identifiers associated with the femto OOB access point in response to determining the one or more OOB responses originate from the femto OOB access point; and
program code to update a search database stored on the mobile device with the mapping information.

56. The computer program product of claim 55, wherein the first scan type comprises:
program code to transmit a probe request frame on each OOB channel of the plurality of OOB channels containing a broadcast address as a destination and a broadcast identifier (ID) as the OOB ID;
program code to start a probe timer;
program code to listen for the one or more OOB responses;
program code to scan a next OOB channel of the plurality of OOB channels, when one of:
the one or more OOB responses to the transmitted probe request are received on the OOB channel by a minimum channel time determined by the probe timer;
no activity is detected on the OOB channel by a minimum channel time; or
activity is detected on the OOB channel by the minimum channel time and one of:
no probe response is received on the OOB channel by a maximum channel time; or
the one or more OOB responses are received on the OOB channel by a maximum channel time.

57. The computer program product of claim 56, further comprising:
program code to determine that the CSG/hybrid femto access point is not the femto OOB access point when no probe response is received on any of the plurality of OOB channels.

58. The computer program product of claim 55, wherein the first scan type comprises:
program code to listen, by the mobile device, for a beacon on each OOB channel of the plurality of OOB channels;
program code to start a scan timer; and
program code to scan a next OOB channel of the plurality of OOB channels on expiration of the scan timer.

59. The computer program product of claim 58, further comprising:
program code to determine that the CSG/hybrid femto access point is not the femto OOB access point when no beacon is received on any of the plurality of OOB channels.

60. The computer program product of claim 55, further comprising, in response to determination that the CSG/hybrid femto access point is not the femto OOB access point:
program code to detect, by a mobile device, in-band signaling indicating a location of the mobile device within one of:
a union; and
an intersection,
of a set of neighbor macro coverage areas around the CSG/hybrid femto access point;
program code to start a timer in response to the detecting; and
program code to transmit, over in-band signaling, a proximity indication to a serving base station when the timer reaches a predetermined time offset, wherein the proximity indication indicates the mobile device being proximate to the CSG/hybrid femto access point.

61. The computer program product of claim 55, wherein the mapping information comprises one or more of:
OOB identification information; and
OOB channel of operation.

62. The computer program product of claim 55, further comprising:
program code to perform a second scan type, by the mobile device, over one or more OOB channels associated with one or more femto OOB access points identified in the mapping information stored in the search database after performing the first scan type;
program code to receive, at the mobile device, one or more responses in response to the second scan type; and
program code to report a proximity indication, by the mobile device, over an in-band link, wherein the proximity indication indicates proximity of the mobile device to one or more responding femto OOB access points from which the one or more responses are received.

63. The computer program product of claim 62, wherein the second scan type is performed on visits to a coverage area of the CSG/hybrid femto access point subsequent to execution of the code to perform the first scan type.

64. The computer program product of claim 62, wherein the second scan type is performed after determining a location of the mobile device within one of:
a union; and
an intersection,
of a set of neighbor macro coverage areas around the CSG/hybrid femto OOB access point.

65. A computer program product for wireless communications in a wireless network, comprising:
a non-transitory computer-readable medium having program code recorded thereon, the program code including:
program code to perform a second scan type, by a mobile device, over one or more out-of-band (OOB) channels associated with one or more femto OOB access points identified in a search database stored on the mobile device;
program code to receive, at the mobile device, one or more responses in response to the second scan type; and
program code to report a proximity indication, by the mobile device, over an in-band link, wherein the proximity indication indicates proximity of the mobile device to one or more responding femto OOB access points from which the one or more responses are received.

66. The computer program product of claim 65, wherein the second scan type comprises:
program code to listen, by the mobile device, for a beacon on each OOB channel of the one or more OOB channels associated with the one or more femto OOB access points;
program code to start a scan timer; and
program code to scan a next OOB channel of the one or more OOB channels on expiration of the scan timer.

67. The computer program product of claim 65, wherein the second scan type comprises:
program code to transmit a probe request on each OOB channel of the one or more OOB channels associated with the one or more femto OOB access points;
program code to start a probe timer;
program code to listen for one or more probe responses on each of the one or more OOB channels; and
program code to transmit the probe request on a next OOB channel of the one or more OOB channels on expiration of the probe timer.

68. The computer program product of claim 65, wherein the second scan type is performed after an in-band determination of a location of the mobile device within one of:
a union; and
an intersection,
of a set of neighbor macro coverage areas around the CSG/hybrid femto OOB access point.

69. The computer program product of claim 68, further comprising:
program code to delay performance of the second scan type after expiration of a predetermined time offset, wherein the predetermined time offset begins in response to the in-band determination of the location of the mobile device.

70. The computer program product of claim 69, wherein the predetermined time offset is based, at least in part, on a relationship between a fingerprint coverage area defined by one of: the union and the intersection, of the set of neighbor macro coverage areas and a femto coverage area of the CSG/hybrid femto OOB access point.

71. The computer program product of claim 65, further comprising:
program code to reset a counter after receiving a list of the one or more femto OOB access points for the search database, wherein the list includes OOB identification information associated with the one or more femto OOB access points;
program code to increment the counter when no responses are received in response to the second scan type;
program code to compare the incremented counter with a predetermined number;
program code to re-perform the second scan type after a predetermined time interval in response to the incremented counter not exceeding the predetermined number; and
program code to perform a full scan to update the list in response to the incremented counter exceeding the predetermined number.

72. The computer program product of claim 71, wherein the predetermined number is based on a number of second scan type searches, in which second scan type searches performed in excess of the number would not significantly increase the probability of detecting the one or more femto OOB access points over the one or more OOB channels.

73. The computer program product of claim 71, wherein the OOB identification information includes one or more of:
channel of operation; and
OOB identifier.

74. The computer program product of claim 65, further comprising:
program code to start a timer, when the second scan type is performed on an OOB channel of the one or more OOB channels;
program code to listen for the one or more responses;
program code to perform the second scan type on a next OOB channel of the one or more OOB channels, when one of:
the one or more responses to the second scan type are received on the OOB channel by a first time window determined by the timer;
no activity is detected on the OOB channel by the first time window; or
activity is detected on the OOB channel by the minimum channel time and one of:
no probe response is received on the OOB channel by a maximum channel time; or
the one or more probe responses are received on the OOB channel by a maximum channel time.

75. The computer program product of claim 68, further comprising, for each OOB channel of the one or more OOB channels on which a plurality of femto OOB access points of the one or more femto OOB access points is associated, as identified in the search database:
program code to transmit a broadcast probe having a broadcast address and broadcast OOB identifier.

76. The computer program product of claim 75, further comprising:
program code to receive a probe response to the broadcast probe; and
program code to determine, prior to reporting the proximity indication, which one of the plurality of femto OOB access points on the each OOB channel transmitted the received probe response.

77. The computer program product of claim 65, further comprising:
program code, executable prior to executing the program code to perform the second scan type, to perform a first scan type, by the mobile device, wherein the first scan type identifies the one or more femto OOB access points, associates the one or more OOB channels to the identified one or more femto OOB access points, and stores identification of the one or more femto OOB access points and the associated one or more OOB channels to the search database on the mobile device.

78. The computer program product of claim 77, wherein program code to perform the first scan type comprises:
program code to perform the first scan type over a plurality of out-of-band (OOB) channels for OOB signals associated with the CSG/hybrid femto access point, wherein the first scan type is performed in response to detecting each of the one or more femto OOB access points for a first time over an in-band channel;
program code to determine, at the mobile device, whether one or more OOB responses originate from a femto OOB access point, wherein the one or more OOB responses are detected in response to the first scan type;
program code to generate, by the mobile device, mapping information mapping one or more OOB identifiers associated with the femto OOB access point with one or more in-band identifiers associated with the femto OOB access point in response to determining the one or more OOB responses originate from the femto OOB access point; and
program code to update the search database stored on the mobile device with the mapping information.

79. The computer program product of claim 78, wherein the mapping information comprises one or more of:
OOB identification information; and
OOB channel of operation.

80. A computer program product for wireless communications in a wireless network, comprising:
a non-transitory computer-readable medium having program code recorded thereon, the program code including:
program code to detect, by a mobile device, a location of the mobile device within at least one neighbor macro coverage areas around the CSG/hybrid femto access point;
program code to start a timer executable in response to results of executing the program code to detect; and
program code to transmit, over in-band signaling, a proximity indication to a serving base station when the timer reaches a predetermined time offset, wherein the proximity indication indicates the mobile device being proximate to the CSG/hybrid femto access point.

81. The computer program product of claim 80, wherein the predetermined time offset is based, at least in part, on a relationship between a fingerprint coverage area defined by one of: the union and the intersection, of a plurality of neighbor macro coverage areas and a femto coverage area of the CSG/hybrid femto access point.

82. An apparatus configured for wireless communication, the apparatus comprising:
at least one processor; and
a memory coupled to the at least one processor,
wherein the at least one processor is configured:
to performing a first scan type, by a mobile device, over a plurality of out-of-band (OOB) channels for OOB signals associated with the CSG/hybrid femto access point, wherein the first scan type is performed in response to detecting the CSG/hybrid femto access point for a first time over an in-band channel;
to determine, at the mobile device, whether one or more OOB responses originate from a femto OOB access point, wherein the one or more OOB responses are detected in response to the first scan type;
to generate, by the mobile device, mapping information mapping one or more OOB identifiers associated with the femto OOB access point with one or more in-band identifiers associated with the femto OOB access point in response to determining the one or more OOB responses originate from the femto OOB access point; and
to update a search database stored on the mobile device with the mapping information.

83. The apparatus of claim 82, wherein the first scan type comprises configuration of the at least one processor:
to transmit a probe request frame on each OOB channel of the plurality of OOB channels containing a broadcast address as a destination and a broadcast identifier (ID) as the OOB ID;
to start a probe timer;
to listen for the one or more OOB responses;
to scan a next OOB channel of the plurality of OOB channels, when one of:
the one or more OOB responses to the transmitted probe request are received on the OOB channel by a minimum channel time determined by the probe timer;
no activity is detected on the OOB channel by a minimum channel time; or
activity is detected on the OOB channel by the minimum channel time and one of:
no probe response is received on the OOB channel by a maximum channel time; or
the one or more OOB responses are received on the OOB channel by a maximum channel time.

84. The apparatus of claim 83, wherein the at least one processor is further configured:
to determine that the CSG/hybrid femto access point is not the femto OOB access point when no probe response is received on any of the plurality of OOB channels.

85. The apparatus of claim 82, wherein the first scan type comprises configuration of the at least one processor:
to listen, by the mobile device, for a beacon on each OOB channel of the plurality of OOB channels;
to start a scan timer; and
to scan a next OOB channel of the plurality of OOB channels on expiration of the scan timer.

86. The apparatus of claim 85, wherein the at least one processor is further configured:
to determine that the CSG/hybrid femto access point is not the femto OOB access point when no beacon is received on any of the plurality of OOB channels.

87. The apparatus of claim 82, wherein the at least one processor is further configured, in response to determination that the CSG/hybrid femto access point is not the femto OOB access point:
to detect, by a mobile device, in-band signaling indicating a location of the mobile device within one of:
a union; and
an intersection,
of a set of neighbor macro coverage areas around the CSG/hybrid femto access point;
to start a timer in response to the detecting; and
to transmit, over in-band signaling, a proximity indication to a serving base station when the timer reaches a predetermined time offset, wherein the proximity indication indicates the mobile device being proximate to the CSG/hybrid femto access point.

88. The apparatus of claim 82, wherein the mapping information comprises one or more of:
OOB identification information; and
OOB channel of operation.

89. The apparatus of claim 82, wherein the at least one processor is further configured:
to perform a second scan type, by the mobile device, over one or more OOB channels associated with one or more femto OOB access points identified in the mapping information stored in the search database after performing the first scan type;
to receive, at the mobile device, one or more responses in response to the second scan type; and
to report a proximity indication, by the mobile device, over an in-band link, wherein the proximity indication indicates proximity of the mobile device to one or more responding femto OOB access points from which the one or more responses are received.

90. The apparatus of claim 89, wherein the second scan type is performed on visits to a coverage area of the CSG/hybrid femto access point subsequent to performance of the first scan type.

91. The apparatus of claim 89, wherein the second scan type is performed after determining a location of the mobile device within one of:
a union; and
an intersection,
of a set of neighbor macro coverage areas around the CSG/hybrid femto OOB access point.

92. An apparatus configured for wireless communication, the apparatus comprising:
at least one processor; and
a memory coupled to the at least one processor,
wherein the at least one processor is configured:
to perform a second scan type, by a mobile device, over one or more out-of-band (OOB) channels associated with one or more femto OOB access points identified in a search database stored on the mobile device;
to receive, at the mobile device, one or more responses in response to the second scan type; and
to report a proximity indication, by the mobile device, over an in-band link, wherein the proximity indication indicates proximity of the mobile device to one or more responding femto OOB access points from which the one or more responses are received.

93. The apparatus of claim 92, wherein the second scan type comprises configuration of the at least one processor:
to listen, by the mobile device, for a beacon on each OOB of the one or more OOB channels associated with the one or more femto OOB access points;
to start a scan timer; and
to scan a next OOB channel of the one or more OOB channels on expiration of the scan timer.

94. The apparatus of claim 92, wherein the second scan type comprises configuration of the at least one processor:
to transmit a probe request on each OOB channel of the one or more OOB channels associated with the one or more femto OOB access points;
to start a probe timer;
to listen for one or more probe responses on each of the one or more OOB channels; and
to transmit the probe request on a next OOB channel of the one or more OOB channels on expiration of the probe timer.

95. The apparatus of claim 92, wherein the second scan type is performed after an in-band determination of a location of the mobile device within one of:
a union; and
an intersection,
of a set of neighbor macro coverage areas around the CSG/hybrid femto OOB access point.

96. The apparatus of claim 95, wherein the at least one processor is further configured:
to delay performance of the second scan type after expiration of a predetermined time offset, wherein the predetermined time offset begins in response to the in-band determination of the location of the mobile device.

97. The apparatus of claim 96, wherein the predetermined time offset is based, at least in part, on a relationship between a fingerprint coverage area defined by one of: the union and the intersection, of the set of neighbor macro coverage areas and a femto coverage area of the CSG/hybrid femto OOB access point.

98. The apparatus of claim 92, wherein the at least one processor is further configured:
to reset a counter after receiving a list of the one or more femto OOB access points for the search database, wherein the list includes OOB identification information associated with the one or more femto OOB access points;
to increment the counter when no responses are received in response to the second scan type;
to compare the incremented counter with a predetermined number;
to re-perform the second scan type after a predetermined time interval in response to the incremented counter not exceeding the predetermined number; and
to perform a full scan to update the list in response to the incremented counter exceeding the predetermined number.

99. The apparatus of claim 98, wherein the predetermined number is based on a number of second scan type searches, in which second scan type searches performed in excess of the number would not significantly increase the probability of detecting the one or more femto OOB access points over the one or more OOB channels.

100. The apparatus of claim 98, wherein the OOB identification information includes one or more of:
channel of operation; and
OOB identifier.

101. The apparatus of claim 92, wherein the at least one processor is further configured:
to start a timer, when the second scan type is performed on an OOB channel of the one or more OOB channels;
to listen for the one or more responses;
to perform the second scan type on a next OOB channel of the one or more OOB channels, when one of:
the one or more responses to the second scan type are received on the OOB channel by a first time window determined by the timer;
no activity is detected on the OOB channel by the first time window; or
activity is detected on the OOB channel by the minimum channel time and one of:
no probe response is received on the OOB channel by a maximum channel time; or
the one or more probe responses are received on the OOB channel by a maximum channel time.

102. The apparatus of claim 95, wherein the at least one processor is further configured, for each OOB channel of the one or more OOB channels on which a plurality of femto OOB access points of the one or more femto OOB access points is associated, as identified in the search database:
to transmit a broadcast probe having a broadcast address and broadcast OOB identifier.

103. The apparatus of claim 102, wherein the at least one processor is further configured:
to receive a probe response to the broadcast probe; and
to determine, prior to reporting the proximity indication, which one of the plurality of femto OOB access points on the each OOB channel transmitted the received probe response.

104. The apparatus of claim 92, wherein the at least one processor is further configured:
to perform a first scan type, by the mobile device, prior to the performance of the second scan type, wherein the first scan type identifies the one or more femto OOB access points, associates the one or more OOB channels to the identified one or more femto OOB access points, and stores identification of the one or more femto OOB access points and the associated one or more OOB channels to the search database on the mobile device.

105. The apparatus of claim 104, wherein configuration of the at least on processor to perform the first scan type comprises configuration:
to perform the first scan type over a plurality of out-of-band (OOB) channels for OOB signals associated with the CSG/hybrid femto access point, wherein the first scan type is performed in response to detecting each of the one or more femto OOB access points for a first time over an in-band channel;
to determine, at the mobile device, whether one or more OOB responses originate from a femto OOB access point, wherein the one or more OOB responses are detected in response to the first scan type;
to generate, by the mobile device, mapping information mapping one or more OOB identifiers associated with the femto OOB access point with one or more in-band identifiers associated with the femto OOB access point in response to determining the one or more OOB responses originate from the femto OOB access point; and
to update the search database stored on the mobile device with the mapping information.

106. The apparatus of claim 105, wherein the mapping information comprises one or more of:
OOB identification information; and
OOB channel of operation.

107. An apparatus configured for wireless communication, the apparatus comprising:
at least one processor; and
a memory coupled to the at least one processor,
wherein the at least one processor is configured:
to detect, by a mobile device, a location of the mobile device within at least one neighbor macro coverage areas around the CSG/hybrid femto access point;
to start a timer in response to the detection; and
to transmit, over in-band signaling, a proximity indication to a serving base station when the timer reaches a predetermined time offset, wherein the proximity indication indicates the mobile device being proximate to the CSG/hybrid femto access point.

108. The apparatus of claim 107, wherein the predetermined time offset is based, at least in part, on a relationship between a fingerprint coverage area defined by one of: the union and the intersection, of a plurality of neighbor macro coverage areas and a femto coverage area of the CSG/hybrid femto access point.
